(19) United States
(12) Patent Application Publication
(10) Pub. No.: US 2026/0212474 A1
(43) Pub. Date: Jul. 23, 2026

(54) COMPUTER VISION IMAGE QUALITY SYSTEM

(71) Applicant: Walmart Apollo, LLC, Bentonville, AR (US)

(72) Inventors: Abhinav Pachauri, Banglore (IN); Han Zhang, Allen, TX (US); Aadarsh Gupta, Dallas, TX (US); Zhaoliang Duan, Frisco, TX (US); Eric W. Rader, Plano, TX (US); Lingfeng Zhang, Flower Mound, TX (US); Mingquan Yuan, Flower Mound, TX (US); Benjamin Ellison, San Francisco, CA (US); Raghava Balusu, Achanta (IN); Avinash Madhusudanrao Jade, Bangalore (IN)

(21) Appl. No.: 19/032,079

(22) Filed: Jan. 19, 2025

(51) Int. Cl. G06T 7/00; G06T 7/55; G06V 10/25; G06V 10/26; G06V 10/764; G06V 10/776; G06V 10/94

(52) U.S. Cl. CPC G06T 7/0002; G06T 7/55; G06V 10/25; G06V 10/764; G06V 10/776; G06T 2200/24; G06T 2207/20081; G06T 2207/30168; G06V 10/273; G06V 10/95

(57) ABSTRACT

Examples provide image quality assessment using computer vision (CV) object detection and recognition with depth estimation. An image quality manager obtains image quality analysis data, including CV object recognition results and depth information for objects of interest. The image analysis data is analyzed to identify image quality issues present in the images. The type of image quality issues includes object detection type, depth type, and payload type issues, such as images with inconsistent distance from an object of interest, images in which the object of interest is either too close or too far away, images having excessive time gaps between images, payloads with too few images, payloads without object detections, etc. Image quality feedback identifying the type of image quality issues detected is generated and provided to users. The system uses image quality feedback to retrain the CV models. The feedback optionally includes suggested actions for resolving the detected issues.

### BACKGROUND

Image recognition as a service (IRAS) is used to analyze images of pallets and/or products in a store or distribution center (DC). Computer vision (CV) image analysis can be used to detect and recognize varieties of objects of interest appearing in images, such as items, pallets, price tags, location tags etc. If the input source images captured by an image capture device are defective, of poor quality, or fail to adequately capture images of relevant object of interest, then downstream processes utilizing those images for CV analysis, inventory tasks, and other processes can be hindered, delayed, or otherwise fail to operate as desired. Many image quality related issues can easily go undetected or may be detected too late to prevent delays or occurrence of errors and other problems with downstream processes utilizing object detection results generated based on the problematic source images. Manual detection and identification of source image quality issues is inefficient, unreliable, labor intensive, error prone, and time-consuming.

### SUMMARY

Some embodiments provide a system for image quality assessment using computer vision (CV) and depth estimation. The system includes an image capture device associated with a mobile robotic device. The image capture device generates a plurality of images of an object of interest associated with a selected area within a field of view of the image capture device. The plurality of images are generated during a predetermined time period. An image quality manager component obtains image analysis results associated with the plurality of images from a machine learning (ML) CV model and a depth model. The image analysis results include object recognition results and depth information associated with the object of interest. A type of an image quality issue associated with the plurality of images is identified from a plurality of types of image quality issues using the image analysis results associated with the plurality of images, the plurality of types comprising an object detection type of the image quality issue, a depth type of the image quality issue, and an image payload type of the image quality issue. Image quality feedback associated with the plurality of images is generated. The image quality feedback comprising the type of the image quality issue and payload data associated with the plurality of images.

Other embodiments provide a method for image quality assessment using computer vision (CV). A plurality of images generated by an image capture device associated with a mobile robotic device during a predetermined time period is obtained. Object detection results associated with the plurality of images are generated by one or more machine learning (ML) CV models. The object detection results associated with an object of interest located with a selected area and payload data associated with the plurality of images are analyzed. A type of an image quality issue associated with the plurality of images is identified from a plurality of types of image quality issues using the object detection results. Image quality feedback associated with the plurality of images is generated. The image quality feedback includes the type of the image quality issue, and the payload data associated with the plurality of images.

Still other embodiments provide an image quality manager that obtains object recognition results for an object of interest associated with images from a machine learning (ML) CV model. Depth information is obtained from a depth model. The images are generated by an image capture device. Image analysis is performed using the object recognition results, the depth information and payload data. A type of image quality issues associated with the images is identified. Image quality feedback is generated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for image quality assessment associated with images of objects of interest.

FIG. 2 is an exemplary block diagram illustrating a retail environment including a one or more image capture devices associated with one or more mobile robotic devices for generating images of objects of interest.

FIG. 3 is an exemplary block diagram of an image quality manager for performing automated image quality assessment and generating image quality feedback associated with identified types of image quality issues.

FIG. 4 is an exemplary flow chat illustrating operation of the computing device to generate image quality feedback including any task-based instructions associated with correcting the detected image quality issues.

FIG. 5 is an exemplary flow chart illustrating operation of the computing device to generate image analysis results associated with a plurality of images.

FIG. 6 is an exemplary flow chart illustrating operation of the computing device to generate image quality feedback using object detection results, payload data and depth information associated with a plurality of images.

FIG. 7 is an exemplary flow chart illustrating operation of the computing device to generate image quality exceptions based on identified image quality issues.

FIG. 8 is an exemplary image of objects which are too close to an image capture device.

FIG. 9 is an exemplary image of objects which are too far away from an image capture device.

FIG. 10 is an exemplary image of objects in which a camera angle makes it difficult to capture price tags on the objects.

FIG. 11 is an exemplary set of images having different levels of distances between objects of interest and an image capture device.

FIG. 12 is an exemplary set of images having too many different timestamps.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Computer vision object detection and recognition can be used to automatically analyze images of objects to identify the objects appearing in the images, such as products on a shelf in a retail facility. During CV object detection and recognition pre-trained machine learning (ML) models are used to detect and recognize objects of interest in images. The detected objects are enclosed in bounding boxes. The images can be cropped to remove extraneous objects in the image and focus on the objects of interest within the bounding boxes. The objects in the cropped images are used to determine the identification and location of objects in the images. This can be used to enable automatic updating of inventory, identification of out-of-stock items (item outs) for restocking tasks, identifying misplaced items, enabling a customer to checkout without scanning each individual item in a customer's shopping cart, identify a location of pallets, locate a specific pallet or other desired object, verify that all items in a shopping cart are scanned after the customer has completed checkout, as well as various other downstream operations. However, these downstream operations require high quality images of the objects of interest, otherwise, the objects of interest may go undetected, or it may not be possible to accurately identify the objects and locations of the objects if the images are of poor quality.

In some solutions, a human user can manually capture images of objects in the retail facility for use in computer vision analysis. However, this is impractical and cost prohibitive in large retail environments containing thousands of different objects of interest. Therefore, the image capture devices are frequently attached to a mobile robotic device which is capable of moving along predetermined routes within a retail environment to capture images of objects of interest for CV object detection and recognition.

CV object detection and recognition issues can occur due to variety of reasons. For example, the image capture device can be too close or too far away from the objects of interest, making the images unusable. This makes it difficult to obtain accurate computer vision object detection and recognition results using images generated by mobile robotic devices roaming around the retail environment.

Failure to obtain accurate object detection and recognition results can be caused due to a variety of reasons, including poor quality (incorrect or bad) source images input from one or more image capture devise on one or more mobile robotic devices. Automatically generated images of poor quality can cause erroneous object identification and/or failure to identify objects of interest, resulting in wasted resources. For example, computer processors, memory and network bandwidth resources are frequently consumed in performing computer vision image recognition as a service (IRAS) analysis of poor quality images from which accurate object detection and recognition cannot be obtained.

Problems associated with poor quality of images generated by a mobile robotic device can, in some cases, be identified and reported manually by human users encountering these issues. The users manually discovering these issues in the input images are frequently tasked with attempting to find out why images of certain objects or images generated in certain areas of the retail environment are of poor quality. However, these manual tasks can be difficult for human users to resolve, and frequently result in inaccurate, inconsistent, and unreliable image quality control for input images, especially in large retail environments in which hundreds or thousands of images are being generated on a daily basis. Thus, manually monitoring images to detect image quality issues by human users can be a laborious, time-consuming, and cost-prohibitive for the human user, as well as consuming system resources utilized during analysis of poor quality images in an effort to obtain computer vision results which are erroneous, inaccurate, inconsistent, and/or unreliable.

In some embodiments, it is desirable to obtain or generate high quality images having sufficient quality for accurate computer vision object detection and recognition, computer vision systems require a number of images of each object captured within a relatively short time period without large gaps in time between generation of each image. Therefore, more accurate and reliable detection of image quality issues associated with input source images generated by image capture devices on mobile robotic devices moving around within a retail environment are desirable for more accurate image quality assessment, improved image quality control, and reduced usage of system resources consumed by computer vision detection and recognition of objects of interest.

Referring to the figures, examples of the disclosure enable automated image quality assessment using computer vision (CV) object detection and recognition results, depth information obtained from a depth model and/or payload data associated with images of objects captured by an image capture device. In some examples, the system enables automated detection of images in which an object of interest remains undetected, such as an item of interest, a price tag, a location tag, or any other object of interest. The system further enables detection of images having multiple location tag detections. These images having multiple location tags and/or failure to detect an object of interest are flagged as having an image quality issue. The system identifies the type of issues and determines if additional action is required to mitigate or correct the issue before other object detection related tasks are impacted. Other object related tasks can include inventory updates, identification of item outs (out-of-stock items), identification of misplaced items, identification of pallet locations, etc. This enables more accurate and efficient automated inventory tasks while reducing errors due to image quality issues impacting object detection and recognition.

In other embodiments, the system automatically identifies payload type image quality issues, such as, but not limited to, a set of images (image payload) having an insufficient number of images of objects within a selected area and/or a set of images having time gaps between images which are too far apart, such as where a time gap exceeds a maximum threshold gap time. This enables identification of mechanical or operational issues associated with the image capture device or the mobile robotic device to which the image capture device is attached. This further reduces errors associated with downstream CV result operations, such as inventory tasks.

In still other embodiments, the system automatically identifies depth type image quality issues in which the mobile robotic device capturing images of objects in a given area using one or more image capture devices is too close to the objects of interest, too far away from the objects of interest, and/or the distance between the image capture device(s) and the objects of interest are inconsistent due to a failure of the mobile robotic device to maintain a consistent distance from the objects of interest, such as shelving units, refrigerated display cases, pallets, cases of items, etc. Identification of depth related image quality issues enables users to more quickly determine the cause of the issue and employ corrective measures to ensure future images generated by the mobile robotic device are of sufficient quality to enable accurate CV object detection and recognition.

The computing device operates in an unconventional manner by automatically identifying and classifying image quality issues associated with images generated using a mobile robotic device. The system identifies the issues and alerts users as to the type of image quality issues that are detected and/or recommends appropriate action to correct the issue. In this manner, the computing device is used in an unconventional manner and allows improved CV object detection and recognition using images generated by a robotic device with minimal human intervention for reduced error rate and improved user efficiency, thereby improving functioning of the underlying computing device.

In still other embodiments, the image quality manager enables identification of problems associated with images being generated by robotic image capture devices for faster resolution of the image quality issues. This minimizes downtime during which the CV systems are unable to accurately identify the location of objects of interest within a retail environment. The system further reduces the number of poor quality images being stored, thereby conserving both memory and data storage device usage.

The system, in still other embodiments, generates image quality feedback identifying image quality issues which is presented to a user via a user interface device. The feedback alerts users to image quality issues before a human user becomes aware of a problem with the robotic device and/or image capture device. The feedback optionally includes instructions for investing the issue and/or correcting the issue. This enables improved user efficiency via UI interaction and increased user interaction performance with a reduced CV object detection error rate.

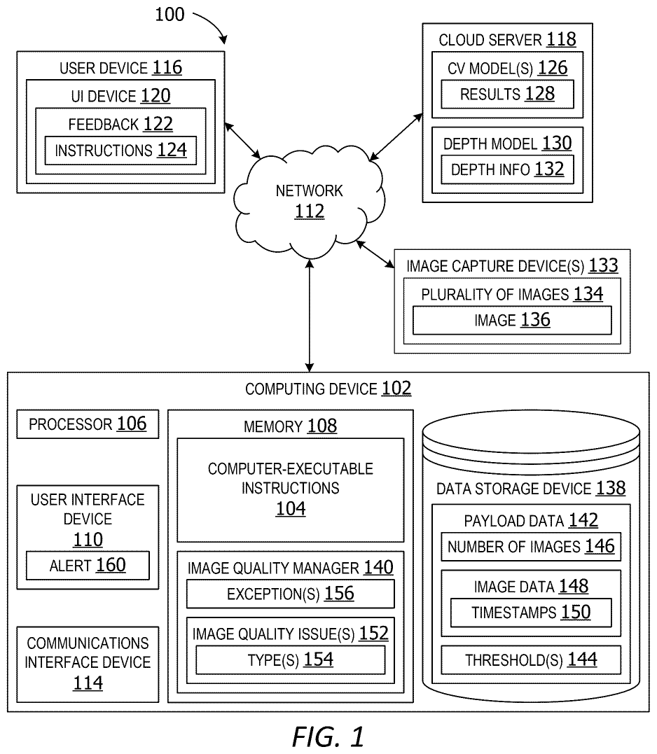

Referring again to FIG. 1, an exemplary block diagram illustrates a system 100 for image quality assessment associated with images of objects of interest. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

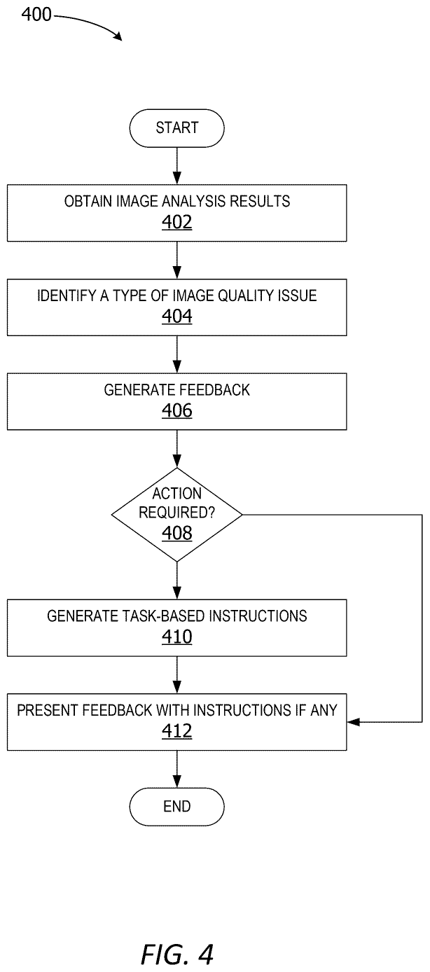

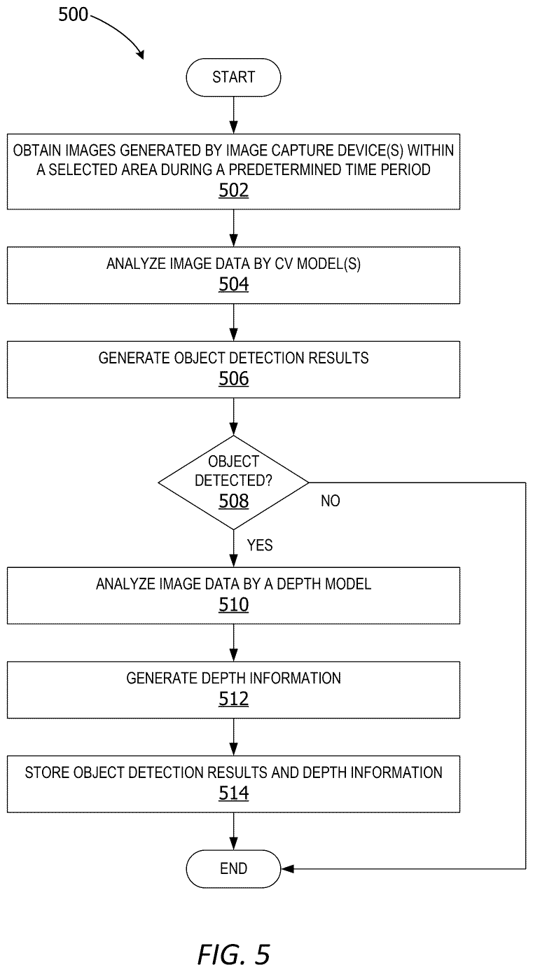

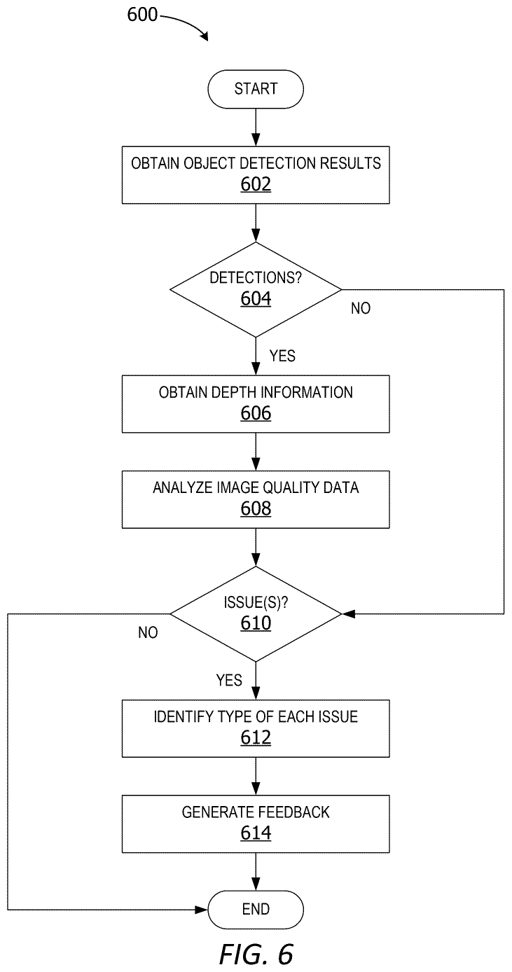

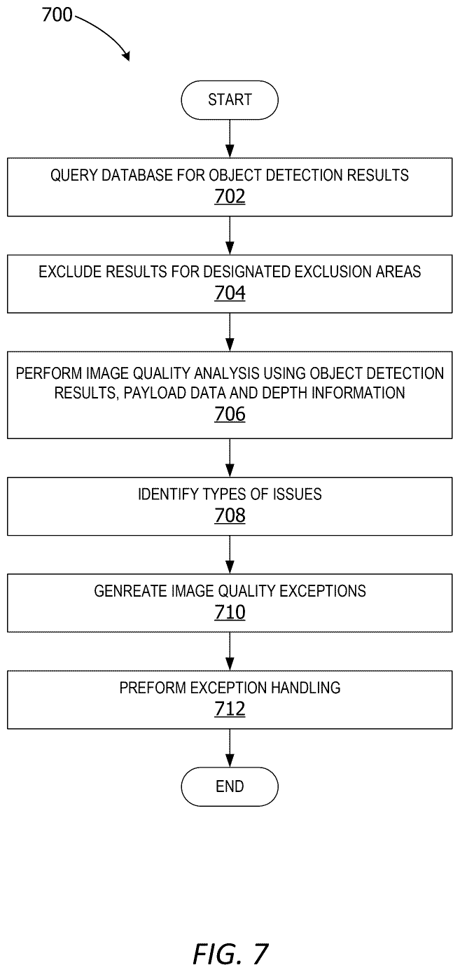

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 4, FIG. 5, FIG. 6, and FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user interface a user device 116, a cloud server 118 and/or one or more image capture device(s) 133, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120.

In some embodiments, image quality feedback 122 is presented to a user via the UI device 120. The feedback 122 optionally includes task-based instructions 124. The instructions 124 can include instructions for addressing a potential cause of an image quality issue. For example, if an image quality issue is a depth issue associated with images indicating the image capture device is too close or too far from the objects of interest, the instructions may include directions to re-adjust a route of the robotic device to correct the distance between the robotic device and the objects of interest, such as a bin containing products on display in a retail facility. In some examples, a bin is an item storage structure for storing items. A bin can include a tote, shelf, pallet reserve area, etc.

In other examples, the instructions 124 can include an instruction for a human user to locate and remove an obstacle which is preventing the robotic device from capturing images of objects from an appropriate distance away from the objects of interest.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In some embodiments, the cloud server 118 includes one or more machine learning (ML) computer vision (CV) model(s) 126. Each ML CV model is a pre-trained image recognition as a service (IRAS) model trained for object detection and recognition. A trained ML CV model analyzes images and detects and recognizes objects of interest. The CV model(s) 126 generate object recognition results 128. The object recognition results 128 include the results generated by each CV model. The object recognition results include an identification of each object of interest detected in the images. For example, a CV model trained to detect a vertical bar on a shelf or bin generates object recognition results identifying each instance of a vertical bar in each image in a plurality of images 134, such as the image 136.

In another example, a CV model in the CV model(s) 126 trained to detect a location tag or a price tag generates object detection results including an identification of each location tag or price tag detected in each image in the plurality of images. Optical character recognition (OCR) is used to read text on location tags and/or price tags detected by the CV model(s) 126.

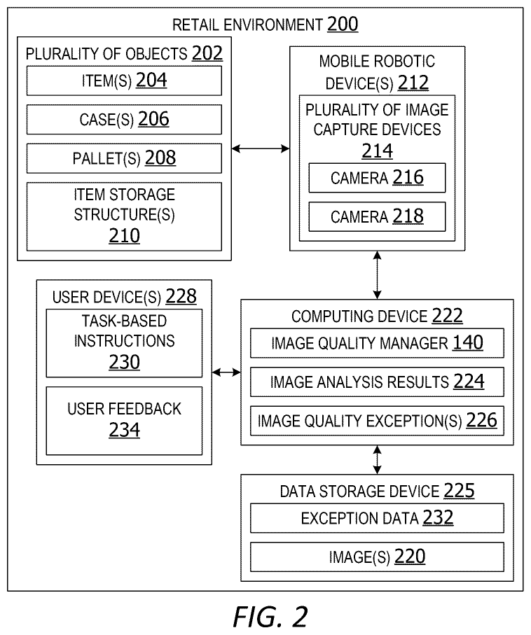

The image capture device(s) 133 include one or more image capture devices, such as a digital camera, infrared (IR) camera, or any other type of image capture device. The image capture device can generate still images and/or video. The image capture device(s) 133 can include color cameras and/or black and white cameras. An image capture device can include a camera mounted on a robotic device, such as, but not limited to, the one or more mobile robotic device(s) 212 in FIG. 2 below. An image capture device removably mounted on a robotic device generates images of objects within the field of view of the image capture device. As the robotic device moves about within the retail environment, the field of view of the image capture device changes. The image capture devices generates consecutive images of the one or more object(s) within the changing field of view, enabling the system to generate overlapping images of the object(s).

The system 100 can optionally include a data storage device 138 for storing data, such as, but not limited to payload data 142 and/or one or more threshold(s) 144. The payload data 142 is data associated with a payload of images. A payload of images is a set of overlapping images captured by an image capture device during a predetermined time period. The payload of images includes images of a selected area captured during a predetermined time period. The payload data 142 includes a number of images 146 in the plurality of images 134. The image data 148 is data associated with the plurality of images 134. The image data 148 includes timestamps 150. The timestamps 150 are metadata identifying a time at which each image is generated. The image data 148 includes a timestamp for each image.

The one or more threshold(s) 144 includes threshold values, such as, but not limited to, a threshold distance between an image capture device and an object of interest. In another example, a threshold includes a minimum number of images needed in each image payload generated by the image capture device(s) 120.

The data storage device 138 can include one or more different types of data storage devices, such as, for example, one or more rotating disks drives, one or more solid state drives (SSDs), and/or any other type of data storage device. The data storage device 138 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 138 includes a database.

The data storage device 138 in this example is included within the computing device 102, attached to the computing device, plugged into the computing device, or otherwise associated with the computing device 102. In other examples, the data storage device 138 includes a remote data storage accessed by the computing device via the network 112, such as a remote data storage device, a data storage in a remote data center, or a cloud storage.

The memory 108 in some examples stores one or more computer-executable components, such as, but not limited to, an image quality manager 140. The image quality manager 140, when executed by the processor 106 of the computing device 102, obtains image analysis results associated with the plurality of images 134 from one or more CV model(s) 126 and the depth model 130. In other words, the image quality manager 140 takes inputs from multiple different CV model(s) 126 and/or the depth model 130.

The image analysis results include the object recognition results 128, payload data 142, and the depth information 132. The image quality manager 140 identifies one or more type(s) 154 of an image quality issue associated with the plurality of images from a plurality of types of image quality issues using the image analysis results associated with the plurality of images, the plurality of types comprising an object detection type of the image quality issue, a depth type of the image quality issue, and an image payload type of the image quality issue.

The image quality manager 140, in other embodiments, generates image quality feedback 122 associated with the plurality of images 134. The image quality feedback 122 includes the type of each image quality issue in the one or more identified image quality issue(s) 152 associated with the plurality of images 134.

In still other embodiments, the image quality manager 140 generates an alert 160 to inform one or more users of a problem with the robotic device and/or the one or more image capture device(s) 133 capturing the plurality of images 134. The alert 160 can include a graphic alert, text, audio, haptics, and/or any other type of output to the user via a user interface, such as, but not limited to, the user interface device 110 and/or the UI device 120. The alert 160 optionally includes the feedback 122 and/or an identification of the type of image quality issue detected by the image quality manager 140.

In this example, the image quality manager 140 is located on the computing device 102. However, in other embodiments, the image quality manager 140 is located on a cloud server, such as the cloud server 118.

The system 100, in some embodiments, enables automation of identifying one or more exception(s) 156 associated with the images used to detect and recognize objects of interest using computer vision. The system is easily scalable such that additional exceptions can be added. It also provides a feedback loop for the source image capture system.

In this example, the image quality manager 140 is detecting the image quality issues and generating the alert 160. However, in other embodiments, the image quality manager 140 detects the image quality issues, and a separate alerting component generates the alert 160.

FIG. 2 is an exemplary block diagram illustrating a retail environment 200 including a one or more image capture devices associated with one or more mobile robotic devices for generating images of objects of interest. The retail environment 200 is any type of retail environment, such as, but not limited to, a retail facility, warehouse, fulfillment center (FC), distribution center (DC), or any other type of retail environment. A retail facility includes any type of store, such as, but not limited to, a grocery store, hardware store, sporting goods store, pet supplies store, garden center, supercenter, wholesale store, warehouse store, etc.

The retail environment 200, in this example, includes a plurality of objects 202. The plurality of objects 202 includes any type of objects of interest, such as one or more item(s) 204, one or more case(s) 206 of items, and/or one or more pallet(s) 208 of items. The item(s) 204 can include any type of object, such as, but not limited to, food items, pet supplies, garden supplies, items of apparel, etc. The plurality of objects 202 can also include one or more item storage structure(s) 210, such as shelves, display cases, totes, bins, or any other type of item storage structure within a retail environment.

One or more mobile robotic device(s) 212 having a plurality of image capture devices 214 attached to the mobile robotic device(s) 212 capture one or more image(s) 220. The one or more image(s) 220 can include a single still image as well as video. The image(s) 220 can include black-and-white images and/or color images. The image(s) 220 are images of objects of interest, such as, but not limited to, the plurality of images 134 in FIG. 1.

In these embodiments, the image(s) 220 do not include images of users or other individuals within the retail facility. Any images having human users or other objects which are not of interest inadvertently included within the images are removed from the image(s) 220 by cropping the images such that only objects of interest remain in the cropped images. Image(s) do not include images of customers or other human users. Objects of interest include items, such as pallets, cases, individual items, shopping carts, storage units, location tags, price tags, item identification tags, such as universal product code (UPC) tags, etc. Storage units include shelving units, display cases, bins, etc. Shopping carts include traditional shopping carts, flat carts for larger items, hand-held baskets, and other carts and containers for carrying or moving items. Images of users or objects which are not of interest are deleted or otherwise discarded. The cropped images containing only the objects of interest are then analyzed to identify and label the objects of interest within the cropped images.

The image capture devices 214 include devices for generating digital images of objects, such as, but not limited to, the image capture device(s) 120 in FIG. 1. The plurality of image capture devices, in some examples, includes one or more cameras, such as the camera 216 and the camera 218.

In this example, each mobile robotic device has two cameras mounted thereon, a top camera and a bottom camera. However, the embodiments are not limited to two cameras on each mobile robotic device. In other embodiments, a mobile robotic device has a single camera. In still other embodiments, the mobile robotic device includes three or more cameras mounted thereon.

The images, in some embodiments, are transmitted to a computing device 222. The computing device 222 is a device having a processor and a memory, such as, but not limited to, the computing device 102 and/or the user device 116 in FIG. 1. In other embodiments, the image(s) 220 are stored on a data storage device 225. The data storage device 225 is a device for storing data, such as, but not limited to, the data storage device 138 in FIG. 1.

The computing device 222 includes an image quality manager 140 for analyzing image analysis results 224 associated with the image(s) 220. The image analysis results 224 includes object recognition results 128 generated by one or more ML CV models, such as, but not limited to, the one or more CV model(s) 126. If one or more objects of interest are identified, the image analysis results 224 also includes depth information generated by a depth model, such as, but not limited to, the depth model 130 in FIG. 1. The image analysis results 224 also includes payload data, such as the payload data 142 in FIG. 1. The payload data includes data associated with the number of images and/or a timestamp for each image.

The image quality manager 140 generates image quality exception(s) 226 associated with image quality issues detected by the image quality manager 140. The exceptions are output to one or more users via one or more user device(s) 228. In some embodiments, the image quality manager 140 generates task-based instructions 230 for resolving the image quality exception(s) 226.

The task-based instructions 230 can include, for example, an instruction to check a camera angle and/or re-calibrate a camera on a robotic device if the image quality issue is a failure to detect objects of interest due to the camera angle. In another example, the task-based instructions 230 can include an instruction for a user to check a selected area for aisle obstructions if the image quality issues include inconsistent distances between the camera and the objects of interest indicating that the robotic device is maneuvering around possible obstructions in the aisle.

In some embodiments, a user provides user feedback 234 to the image quality manager 140. The user feedback 234 indicates whether performance of task-based instructions 230 resolved the problem causing the image quality issue(s) or if the problem remains unresolved.

In some embodiments, the instructions are dynamic depending on the type of image quality issue or exception. For example, if the issue is a depth issue, the instructions can include instructions to re-route the robotic device having the image capture device(s) generating the images, removing obstacles which are preventing the robotic device from maintaining the proper distance from the produce, making a visual inspection of the selected area to determine the cause of the issue, or any other corrective action. However, if the image quality issue is a failure to detect an object due to the camera angle, the instructions may include directions for a user to re-calibrate the camera angle or make a visual inspection of the robotic device to determine if other repair or maintenance is required to correct the issue.

If the problem is resolved and additional image quality issues of the identified type are no longer detected, the image quality exception is resolved and closed. If the problem remains unresolved and the image quality issue type continues to be detected after actions are taken to mitigate or correct the issue, the image quality exception remains open. In such cases, additional actions may be requested, such as maintenance or repair of the mobile robotic device and/or an image capture device generating the images having the quality issues.

Exception data 232 associated with the one or more image quality exception(s) 226 triggered by the image quality manager 140 are stored in the data storage device. Once an image quality exception is resolved, the exception data 232 is updated to close the exception record for that image quality exception.

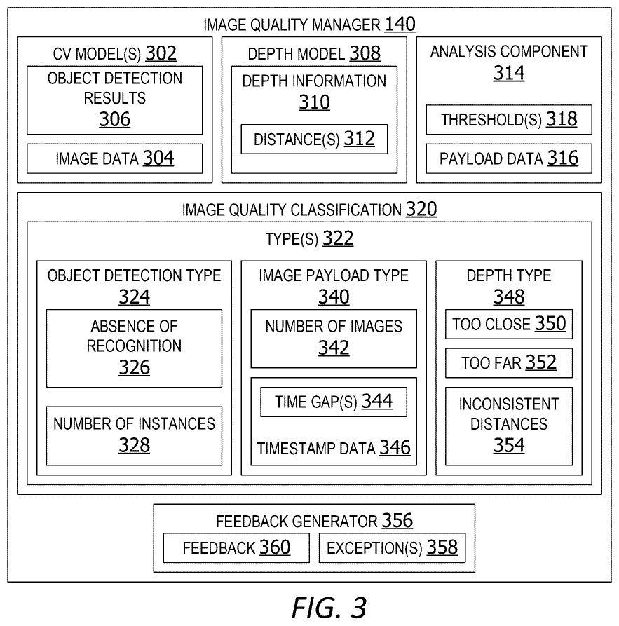

FIG. 3 is an exemplary block diagram of an image quality manager 140 for performing automated image quality assessment and generating image quality feedback associated with identified types of image quality issues. In some embodiments, the image quality manager 140 includes one or more CV model(s) 302. Each CV model in the one or more CV model(s) 302 is a pre-trained ML CV model for performing object detection and recognition using image data 304. The CV model(s) 302 generate object detection results 306 identifying objects of interest detected and recognized in the image data for one or more images.

In this example, the CV model(s) 302 are incorporated into the image quality manager 140. However, in other embodiments, the image quality manager 140 obtains the object detection results 306 from one or more CV model(s) 302 which are not incorporated into the image quality manager 140. For example, the CV model(s) 302 may be hosted on a cloud server, as shown in FIG. 1.

In some embodiments, the image quality manager 140 includes a depth model 308. The depth model 308 is a trained model for identifying a distance between the image capture device and an object of interest depicted in one or more images, such as, but not limited to, the depth model 130 in FIG. 1. The depth model 308 generates depth information 310 identifying the distance(s) 312 between the objects of interest and the image capture device.

In some embodiments, an analysis component 314 analysis the objection detection results 306, the depth information 310 and payload data 316 associated with a plurality of images of objects of interest captured within a selected area during a predetermined time period. The analysis component 314 applies one or more threshold(s) 318 to identify image quality issues associated with the plurality of images.

An image quality classification 320 is a component for identifying one or more image quality type(s) 322 associated with the detected image quality issue(s). The type(s) 322 can include an object detection type 324 associated with object detection results 306 indicating an absence of recognition 326 of one or more objects of interest. For example, if the CV model(s) 302 fails to detect an object of interest, such as a price tag or location tag, within an image, the image quality issue type is an object detection type 324.

The object detection type 324 can also include a number of instances 328 of an object of interest detected in one or more image(s) exceeding a maximum threshold number of instances of the object. For example, if two or more location tags are detected within the one or more images of a selected area, this prevents accurate determination of the location of the object(s) of interest. In this case, the type of issue is also an object detection type 324.

Image payload type 340 refers to a type of image quality issue in which the number of images 342 in the plurality of images falls below a threshold minimum number of images required for accurate object detection. For example, if fifteen to twenty images of a selected area generated within a threshold time period is required for accurate object detection and recognition, an image payload having fewer than fifteen images results in an image payload type of issue.

In other embodiments, the image payload type 340 of image quality issue includes one or more time gap(s) 344 in timestamp data 346 for the plurality of images indicating a gap in the time at which the images were generated that exceeds a threshold maximum time gap. For example, if some of the images were captured an hour after other images in the image payload, then the time gap is too great. In this example, an image payload type of image quality exception is triggered.

A depth type 348 type of image quality issue includes images having a depth or distance that is too close 350 to the image capture device, too far 352 from the image captured device, and/or images having an inconsistent distance 354 between the object(s) of interest and the image capture device.

The image quality manager 140 includes a feedback generator 356 that generates image quality feedback 360. The image quality feedback 360 identifies the type of image quality issues detected based on the images within the image payload. Feedback 360, including one or more image quality types identified from the possible image quality types is generated. The feedback 360 includes image quality feedback associated with one or more images in an image payload, such as, but not limited to, the feedback 122 in FIG. 1.

The feedback generator 356 optionally also triggers one or more image quality exception(s) 358. A different exception is triggered for each different type of image quality issue detected. A single image can have one or more different types of image quality issues. Thus, a single image or payload of images can be associated with one or more image quality exceptions.

FIG. 4 is an exemplary flow chat illustrating operation of the computing device to generate image quality feedback including any task-based instructions associated with correcting the detected image quality issues. The process 400 shown in FIG. 4 is performed by an image quality manager component, executing on a computing device, such as the computing device 102 or the user device 116 in FIG. 1.

The process begins by obtaining image analysis results at 402. Image analysis results include object detection results, depth information and/or payload data, such as, but not limited to, the image analysis results 224 in FIG. 2. A type of image quality issue is identified at 404. The type of issue is determined using the image analysis results. The image quality manager generates feedback at 406. The feedback is image quality feedback identifying the types of detected image quality issues for the image(s), such as, but not limited to, the feedback 122 in FIG. 1 and/or the feedback 360 in FIG. 3. A determination is made whether any action is required at 408. The action is an action to resolve the image quality issue or mitigate the problem by identifying the source of the problem and/or correcting the problem. If no action is required, feedback with instructions, if any, is presented at 412. In this scenario, no instructions are included in the feedback. The feedback is presented via a UI in some embodiments. The process terminates thereafter.

If an action is required at 408, the image quality manager generates task-based instructions at 410. Feedback with instructions, if any, is presented at 412. In this scenario, task-based instructions are included with the feedback. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to generate image analysis results associated with a plurality of images. The process 500 shown in FIG. 5 is performed by an image quality manager component, executing on a computing device, such as the computing device 102 or the user device 116 in FIG. 1.

The process begins by obtaining images generated by one or more image capture device(s) within a selected area during a predetermined time period at 502. Image data associated with the images is analyzed by one or more CV model(s) at 504. The CV model(s) include pre-trained ML CV models, such as, but not limited to, the CV model(s) 126 in FIG. 1 and/or the one or more CV model(s) 302 in FIG. 3. Object detection results are analyzed at 504. The results are analyzed by the one or more CV model(s). Objection detection results are generated at 506. The results are generated by the one or more CV model(s). A determination is made as to whether any object of interest is detected at 508. If not, the process terminates thereafter.

If at least one object of interest is detected at 508, image data is analyzed by a depth model at 510. The depth model is a model trained to identify distances between objects in images and the image capture device, such as, but not limited to, the depth model 130 in FIG. 1 and/or the depth model 308 in FIG. 3. The depth model generates depth information at 512. The depth information includes distances from the image capture device to the objects of interest in one or more of the images associated with the image data. The object detection results, and depth information is stored at 514. In some embodiments, the object detection results, and depth information is stored in a data storage device, such as, but not limited to, the data storage device 138 in FIG. 1 and/or the data storage device 225 in FIG. 2. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to generate image quality feedback using object detection results, payload data and depth information associated with a plurality of images. The process 600 shown in FIG. 6 is performed by an image quality manager component, executing on a computing device, such as the computing device 102 or the user device 116 in FIG. 1.

The process begins by obtaining object detection results at 602. A determination is made whether there are any detections of objects of interest at 604. If yes, depth information for the detected objects in the images is obtained at 606. The image quality data is analyzed at 608. A determination is made whether any image quality issue(s) are detected at 610. The determination is made based on the object detection results, depth information and payload data. If not, the process terminates thereafter.

If one or more image quality issue(s) are detected at 610, the type of each detected issue is identified at 612. The type can include object detection type, depth type, and/or image payload type. Feedback is generated at 614. The feedback includes the identified type of each image quality issue. The process terminates thereafter.

If no objects are detected, the image quality data is analyzed at 608. A determination is made whether any image quality issues are detected at 610. The determination is made based on analysis of the object detection results and payload data. If no issues are detected, the process terminates thereafter.

If one or more image quality issue(s) are detected at 610, the type of each issue is identified at 612. The type can include object detection type and/or image payload type. Feedback is generated at 614. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to generate image quality exceptions based on identified image quality issues. The process 700 shown in FIG. 7 is performed by an image quality manager component, executing on a computing device, such as the computing device 102 or the user device 116 in FIG. 1.

The process begins by querying a database for object detection results at 702. The database is any type of database associated with a data storage device, such as, but not limited to, the data storage device 138 in FIG. 1 and/or the data storage device 225 in FIG. 2. The results for designated exclusion areas are excluded at 704. An exclusion area is an area pre-designated for exclusion from consideration for image quality issues, such as a freezer section. Image quality analysis is performed using object detection results, payload data and depth information at 706. Types of image quality issues are identified at 708. The image quality exceptions are generated at 710. The exception handling is performed at 712. Exception handling includes triggering an exception, creating an image quality exception record, and updating the record when the exception is successfully resolved. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

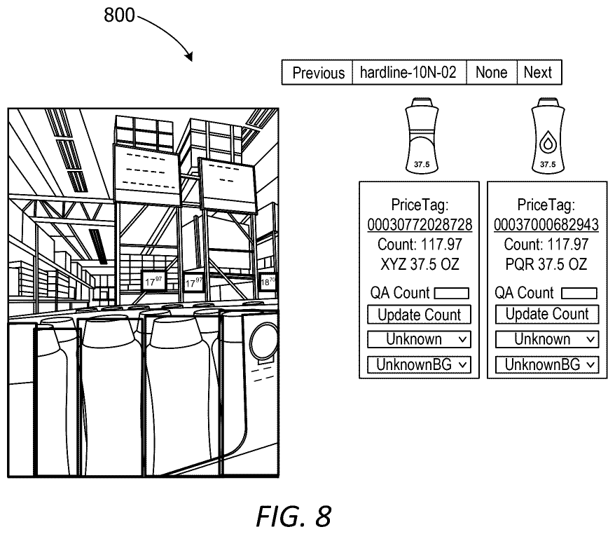

FIG. 8 is an exemplary image 800 of objects which are too close to an image capture device. In this example, the distance between the image capture device and the objects of interest in the image 800 is too short. In other words, the distance is less than a minimum threshold distance.

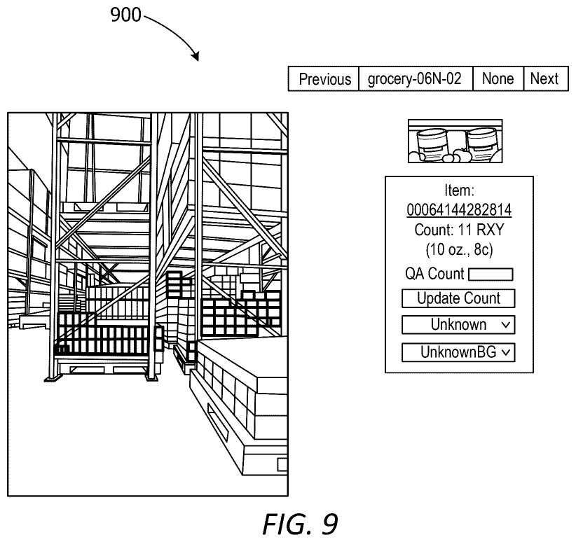

Turning now to FIG. 9, an exemplary image 900 of objects which are too far away from an image capture device is shown. In this example, the distance between the image capture device and the objects of interest in the image 900 is too far. In other words, the distance is greater than a maximum threshold distance.

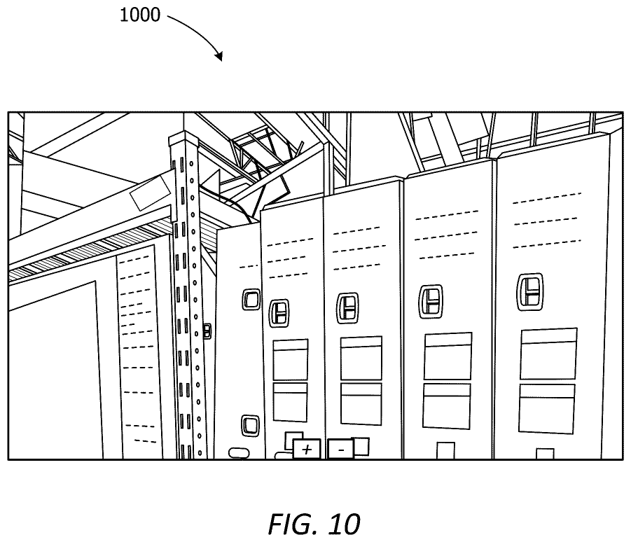

FIG. 10 is an exemplary image 1000 of objects in which a camera angle makes it difficult to capture price tags on the objects. In this example, the angle of the image capture device is such that the image 1000 fails to capture an object of interest, such as a price tag on one or more products.

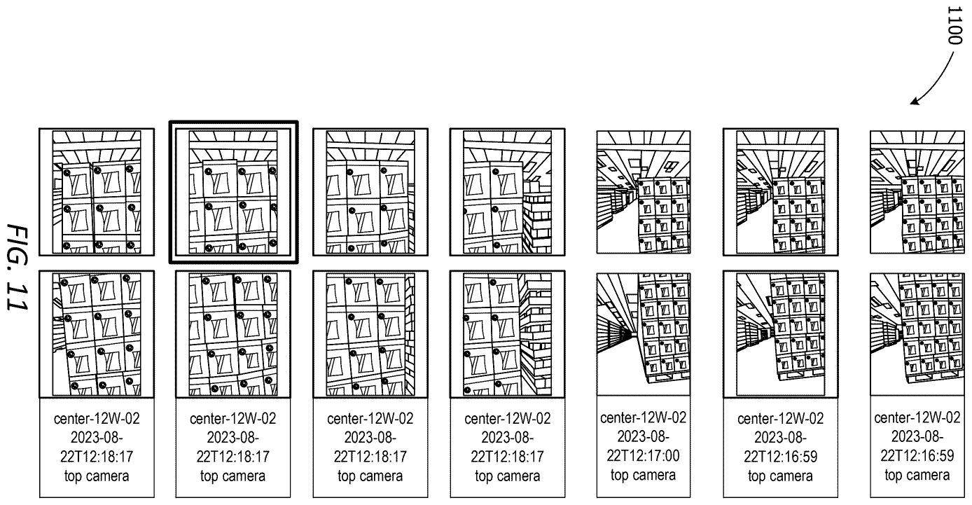

FIG. 11 is an exemplary set of images 1100 having different levels of distances between objects of interest and an image capture device. In this example, the distance between the image capture device and the object of interest is greater in some of the images. The distance between the image capture device and the object of interest is shorter. This can occur, in some examples, if the robotic device containing the image capture device is moving closer to the objects of interest and then farther away from the objects of interest while capturing images of the objects instead of maintaining a constant distance away from the objects.

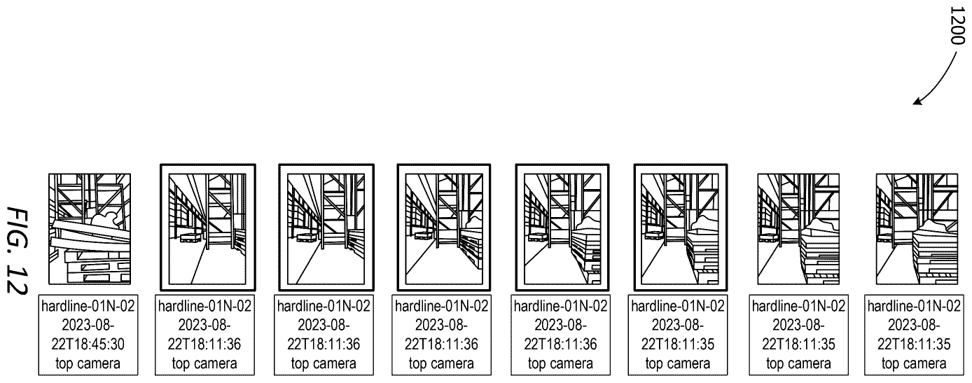

FIG. 12 is an exemplary set of images 1200 having too many different timestamps. In this example, the gap between most of the images is a single second. However, the time gap between the last two images is significantly longer than one second. In this example, the timestamp for one image is 45:30 and the timestamp for another image is 11:36. This represents a time gap which is too long. Changes can occur at the selected location during the time gap which renders the object detection results erroneous. For example, If the time gap exceeds a threshold maximum time gap, object detections obtained using the images can be erroneous.

### Additional Examples

In some examples, the system identifies image quality exceptions associated with images being used to detect and recognize objects of interest using computer vision by robots. The system fetches recognition results for image payloads of recent time (i.e., for last two months from a database). The system identifies and generates exception cases (i.e., flagging them) for the payloads based on image quality analysis. The image quality issues can include payloads with no price detection (no price tag recognized exception); unrecognized or undetected payloads (no product recognized exception); multiple location tags on the payloads (e.g. multiple location tags exception); gaps in the timestamp of the payload images captured for a specific location (e.g. images with too many different timestamps exception); and/or insufficient number of payload images (e.g. images with fewer than the defined threshold of overlapping images exception).

In other embodiments, the system fetches CV results data of the payloads and fetches depth information of the detected payloads from a database. The system analyzes the CV results, depth information, and image metadata to generate feedback. The feedback includes depth-related feedback generating using depth thresholds (e.g., images flagged as camera too close or too far) and/or payloads with inconsistent depth information across images of the same payload (e.g., images showing different levels of distance to the product).

In still other embodiments, the system excludes some regions of interest (i.e., freezer section payloads). The system is scalable such that additional exceptions can be added. The system provides a feedback loop for retraining the computer vision models.

The system, in some embodiments, triggers exceptions and generates task-related instructions for resolving triggered exceptions. The system optionally receives user input indicating if an exception is resolved or unable to be resolved by the user. In a scenario in which an exception is unable to be resolved, the system optionally flags the exception/issue for further action or investigation.

In some embodiments, the system automates the process of image quality analysis and automatically generates exception cases. Source images can have multiple type of exceptions in each image that can cause problems or disruptions in the downstream image analysis pipeline.

In an example scenario, the system fetches image payloads where no price tag prediction is present. If the payload has a price tag detected but still no location prediction occurred, it is a price tag false negative. It is flagged as a bin with no price tag recognized. This is an object detection type of image quality issue detection. If there is no product detected or recognized or the source of detection is ‘unknown,’ it is a selected area (bin) with no product recognized exception. This is also an object detection type of image quality issue.

Depth detection, in some embodiments, is used to detect depth-related image quality issues associated with image distances that are too close, too far, or images that have varying depth. For the image payloads where product (object of interest) is detected and recognized, the system obtains (fetch) depth information of the detected product bounding boxes. The system flags image payloads for selected areas in which objects of interest are too close or too far from the image capture device based on thresholding the depth information of the detected bounding boxes in each of top and bottom cameras separately. For example, if the objects of interest within the field of view of a camera are too close or too far, the system may be unable to detect and read location tags, price tags, and/or recognize objects in the images.

In an example scenario, the distance (depth) for each object detection is obtained. If there is an average depth which is being maintained by the robotic device for all the other aisles, the system compares that distance with the current distance. The average distance is used to calculate a dynamic depth threshold used to determine whether to trigger a depth type exception. The system performs depth anomaly detection using the dynamic depth threshold. If the depth for the detected objects is too far or too close, the system raises an image quality exception for the images.

If the detected object of interest (product) has different depth information across images of the same payload, it is an exception for images having different levels of distances to the product (objects of interest).

In some cases, the system detects too many location tags in images for a single payload. If the payload has more than one location tag prediction, even if it has more than one location tag detection, it is a multiple location tags exception. For example, a single portion of an aisle in a store should not have more than one location tag present. If the images include multiple location tags, it is an error which will result in problems for downstream processing relying on the object detection and recognition. The problems can include erroneous updates to inventory, assigning an incorrect location to an object, identifying multiple locations for the same object, etc.

In some examples, the image payload contains inconsistent timestamps associated with the images. If there is a huge gap in the timestamp of images captured for a specific location, it is a bin with too many different timestamp images.

In other embodiments, the system determines there are not enough images of the object of interest. If the number of images in a single payload of a location is less than a defined threshold, it will be flagged as an insufficient number of images exception.

In an example scenario, the system queries saved IRAS recognition results for payloads created during the last two months from a database. The system excludes freezer section payloads since freezer section contains location tags present in every image. The system fetches payloads where no price tag prediction is present and checks the objection detection results whether that payload has any price tag detection or not. If the payload has price tag detected but still no prediction happened, it is a false negative and is flagged as a payload with no price tag recognized. If there is no product detected or recognized or source of detection is ‘unknown,’ it is flagged as a payload with no product recognized. For the payloads where product is detected and recognized, the system fetches depth information of the detected product bounding boxes. The payloads are flagged which are too close or too far exception based on thresholding the depth information of the detected bounding boxes in each of the top camera generated images and the bottom camera generated images on a given robotic device. The images for the top and bottom cameras are analyzed separately. If the detected products has different depth information across images of the same payload, it is flagged as a payload of images having different levels of distances to the product.

In other embodiments, if a single payload has more than one location tag prediction, it is flagged as a multiple location tags exception. Ideally all the images of a payload should have similar timestamp, or timestamp should be within a small threshold. If there is a significant gap in the timestamp of images captured by robotic device for a specific location, the images are flagged as a payload with too many different timestamp images. These different timestamp images are split into different payloads and should not be part of the same payload. In some examples, a payload should have at least ten to fifteen overlapping images which covers the whole bin (selected area) at a specific location in a club but if the number of images in a single payload of a location is less than the defined threshold, it means there is something wrong either with that location or the robotic device generating the images. It is flagged as a payload for a location with insufficient number of images.

Alternatively, or in addition to the other examples described herein, examples include any combination of the following:
analyze the object recognition results generated by the ML CV model;
identify a set of images in the plurality of images having an absence of recognition of the object of interest within the plurality of images or a number of instances of the object of interest within the plurality of images exceeding a threshold number of instances, the object of interest comprising an information tag;
generate the image quality feedback associated with the set of images, wherein the type of the image quality issue is the object detection type;
analyze the payload data associated with the plurality of images, the payload data including a plurality of timestamps associated with the plurality of images;
identify a set of images in the plurality of images having a time gap in the plurality of timestamps exceeding a maximum threshold time gap;
generate the image quality feedback associated with the set of images, wherein the type of the image quality issue is the image payload type;
analyze the payload data associated with the plurality of images, the payload data including a number of images in the plurality of images;
determine whether the number of images exceeds a threshold minimum number of images;
responsive to the number of images falling below the threshold minimum number of images, generate the image quality feedback associated with the plurality of images, wherein the type of the image quality issue is the image payload type;
analyze the depth information generated by a depth estimation model;
identify a set of images in the plurality of images having a distance between the object of interest and the image capture device that exceeds a maximum threshold distance or falls below a minimum threshold distance;
generate the image quality feedback associated with the set of images, wherein the type of the image quality issue is the depth type;
analyze the depth information generated by a depth estimation model;
identify a set of images in the plurality of images having an inconsistent distance between the object of interest and the image capture device;
generate the image quality feedback associated with the set of images, wherein the type of the image quality issue is the depth type;
trigger an alert including task-based instructions for resolving the image quality issue;
obtaining a plurality of images generated by an image capture device associated with a mobile robotic device during a predetermined time period;
generating, by a plurality of machine learning (ML) CV models, object detection results associated with the plurality of images;
analyzing the object detection results associated with an object of interest

located with a selected area and payload data associated with the plurality of images;
identifying a type of an image quality issue associated with the plurality of images from a plurality of types of image quality issues using the object detection results, the plurality of types comprising an object detection type of the image quality issue and an image payload type of the image quality issue;
generate image quality feedback associated with the plurality of images, the image quality feedback comprising the type of the image quality issue and the payload data associated with the plurality of images;
generating, by a depth estimation model, depth information associated with the plurality of images;
analyzing the depth information associated with the object of interest in each image within the plurality of images;
identifying a set of images in the plurality of images having a distance between the object of interest and the image capture device that exceeds a maximum threshold distance or falls below a minimum threshold distance;
generating the image quality feedback associated with the set of images, wherein the type of the image quality issue is the depth type;
generating, by a depth estimation model, depth information associated with the plurality of images;
analyzing the depth information associated with the object of interest in each image within the plurality of images;
identifying a set of images in the plurality of images having an inconsistent distance between the object of interest and the image capture device;
generating the image quality feedback associated with the set of images, wherein the type of the image quality issue is the depth type;
identifying a set of images in the plurality of images having an absence of recognition of the object of interest within the plurality of images or a number of instances of the object of interest within the plurality of images exceeding a threshold number of instances, the object of interest comprising an information tag associated with an item;
generating the image quality feedback associated with the set of images, wherein the type of the image quality issue is the object detection type;
identifying a set of images in the plurality of images having a time gap in a plurality of timestamps exceeding a maximum threshold time gap or a number of images in the set of images falling below a threshold minimum number of images;
generating the image quality feedback associated with the set of images, wherein the type of the image quality issue is the image payload type;
triggering an alert including task-based instructions for resolving the image quality issue, wherein the task-based instructions are presented to a user via a user interface device; and
providing the image quality feedback to a CV model in the plurality of CV models, wherein the CV model is re-trained using the image quality feedback.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some examples, the operations illustrated in FIG. FIG. 4, FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of image quality assessment, the method comprising obtaining object recognition results for an object of interest associated with a plurality of images from a machine learning (ML) CV model, the plurality of images generated by an image capture device; obtaining depth information associated with the object of interest in the plurality of images from a depth model; performing image analysis using the object recognition results, the depth information, and payload data associated with the plurality of images; identifying a type of an image quality issue associated with the plurality of images from a plurality of types of the image quality issues using the image analysis results associated with the plurality of images, the plurality of types comprising an object detection type of the image quality issue, a depth type of the image quality issue, and an image payload type of the image quality issue; and generating image quality feedback associated with the plurality of images, the image quality feedback comprising the type of the image quality issue and the payload data associated with the plurality of images.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for image quality assessment using CV models and depth information. For example, the elements illustrated in FIG. 1, FIG. 2, and FIG. 3, such as when encoded to perform the operations illustrated in FIG. 4, FIG. 5, FIG. 6, and FIG. 7, constitute exemplary means for obtaining a plurality of images generated by an image capture device associated with a mobile robotic device during a predetermined time period; exemplary means for generating, by a plurality of machine learning (ML) CV models, object detection results associated with the plurality of images; exemplary means for analyzing the object detection results associated with an object of interest located with a selected area and payload data associated with the plurality of images; exemplary means for identifying a type of an image quality issue associated with the plurality of images from a plurality of types of image quality issues using the object detection results, the plurality of types comprising an object detection type of the image quality issue and an image payload type of the image quality issue; and exemplary means for generating image quality feedback associated with the plurality of images, the image quality feedback comprising the type of the image quality issue and the payload data associated with the plurality of images.

Other non-limiting examples provide one or more computer storage devices having a first computer-executable instructions stored thereon for providing image quality assessment. When executed by a computer, the computer performs operations including obtaining image analysis results associated with the plurality of images from a machine learning (ML) CV model and a depth model, the image analysis results comprising object recognition results and depth information associated with the object of interest; identifying a type of an image quality issue associated with the plurality of images from a plurality of types of image quality issues using the image analysis results associated with the plurality of images, the plurality of types comprising an object detection type of the image quality issue, a depth type of the image quality issue, and an image payload type of the image quality issue; and generating image quality feedback associated with the plurality of images, the image quality feedback comprising the type of the image quality issue and payload data associated with the plurality of images.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of′ ”only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for image quality assessment using computer vision (CV) and depth estimation, the system comprising:
an image capture device associated with a mobile robotic device, the image capture device generating a plurality of images of an object of interest associated with a selected area within a field of view of the image capture device, the plurality of images generated during a predetermined time period; and
a computer-readable medium storing instructions that are operative upon execution by a processor to:
obtain image analysis results associated with the plurality of images from a machine learning (ML) CV model and a depth model, the image analysis results comprising object recognition results and depth information associated with the object of interest;
identify a type of an image quality issue associated with the plurality of images from a plurality of types of image quality issues using the image analysis results associated with the plurality of images, the plurality of types comprising an object detection type of the image quality issue, a depth type of the image quality issue, and an image payload type of the image quality issue; and
generate image quality feedback associated with the plurality of images, the image quality feedback comprising the type of the image quality issue and payload data associated with the plurality of images.

2. The system of claim 1, wherein identifying the type of the image quality issue further comprises:
analyze the object recognition results generated by the ML CV model;
identify a set of images in the plurality of images having an absence of recognition of the object of interest within the plurality of images or a number of instances of the object of interest within the plurality of images exceeding a threshold number of instances, the object of interest comprising an information tag; and
generate the image quality feedback associated with the set of images, wherein the type of the image quality issue is the object detection type.

3. The system of claim 1, wherein identifying the type of the image quality issue further comprises:
analyze the payload data associated with the plurality of images, the payload data including a plurality of timestamps associated with the plurality of images;
identify a set of images in the plurality of images having a time gap in the plurality of timestamps exceeding a maximum threshold time gap; and
generate the image quality feedback associated with the set of images, wherein the type of the image quality issue is the image payload type.

4. The system of claim 1, wherein identifying the type of the image quality issue further comprises:
analyze the payload data associated with the plurality of images, the payload data including a number of images in the plurality of images;
determine whether the number of images exceeds a threshold minimum number of images; and
responsive to the number of images falling below the threshold minimum number of images, generate the image quality feedback associated with the plurality of images, wherein the type of the image quality issue is the image payload type.

5. The system of claim 1, wherein identifying the type of the image quality issue further comprises:
analyze the depth information generated by a depth estimation model;
identify a set of images in the plurality of images having a distance between the object of interest and the image capture device that exceeds a maximum threshold distance or falls below a minimum threshold distance; and
generate the image quality feedback associated with the set of images, wherein the type of the image quality issue is the depth type.

6. The system of claim 1, wherein identifying the type of the image quality issue further comprises:
analyze the depth information generated by a depth estimation model;
identify a set of images in the plurality of images having an inconsistent distance between the object of interest and the image capture device; and
generate the image quality feedback associated with the set of images, wherein the type of the image quality issue is the depth type.

7. The system of claim 1, wherein the instructions are further operative to:
trigger an alert including task-based instructions for resolving the image quality issue.

8. A method for image quality assessment using computer vision (CV), the method comprising:
obtaining a plurality of images generated by an image capture device associated with a mobile robotic device during a predetermined time period;
generating, by a plurality of machine learning (ML) CV models, object detection results associated with the plurality of images;
analyzing the object detection results associated with an object of interest located with a selected area and payload data associated with the plurality of images;
identifying a type of an image quality issue associated with the plurality of images from a plurality of types of image quality issues using the object detection results, the plurality of types comprising an object detection type of the image quality issue and an image payload type of the image quality issue; and
generating image quality feedback associated with the plurality of images, the image quality feedback comprising the type of the image quality issue and the payload data associated with the plurality of images.

9. The method of claim 8, further comprising:
generating, by a depth estimation model, depth information associated with the plurality of images;
analyzing the depth information associated with the object of interest in each image within the plurality of images;
identifying a set of images in the plurality of images having a distance between the object of interest and the image capture device that exceeds a maximum threshold distance or falls below a minimum threshold distance; and
generating the image quality feedback associated with the set of images, wherein the type of the image quality issue is the depth type.

10. The method of claim 8, further comprising:
generating, by a depth estimation model, depth information associated with the plurality of images;
analyzing the depth information associated with the object of interest in each image within the plurality of images;
identifying a set of images in the plurality of images having an inconsistent distance between the object of interest and the image capture device; and
generating the image quality feedback associated with the set of images, wherein the type of the image quality issue is the depth type.

11. The method of claim 8, further comprising:
identifying a set of images in the plurality of images having an absence of recognition of the object of interest within the plurality of images or a number of instances of the object of interest within the plurality of images exceeding a threshold number of instances, the object of interest comprising an information tag associated with an item; and
generating the image quality feedback associated with the set of images, wherein the type of the image quality issue is the object detection type.

12. The method of claim 8, further comprising:
identifying a set of images in the plurality of images having a time gap in a plurality of timestamps exceeding a maximum threshold time gap or a number of images in the set of images falling below a threshold minimum number of images; and
generating the image quality feedback associated with the set of images, wherein the type of the image quality issue is the image payload type.

13. The method of claim 8, further comprising:
triggering an alert including task-based instructions for resolving the image quality issue, wherein the task-based instructions are presented to a user via a user interface device.

14. The method of claim 8, further comprising:
providing the image quality feedback to a CV model in the plurality of CV models, wherein the CV model is re-trained using the image quality feedback.

15. One or more computer storage devices having computer-executable instructions stored thereon, which, upon execution by a computer, cause the computer to perform operations comprising:
obtaining object recognition results for an object of interest associated with a plurality of images from a machine learning (ML) CV model, the plurality of images generated by an image capture device;
obtaining depth information associated with the object of interest in the plurality of images from a depth model;
performing image analysis using the object recognition results, the depth information, and payload data associated with the plurality of images;
identifying a type of an image quality issue associated with the plurality of images from a plurality of types of the image quality issues using the image analysis results associated with the plurality of images, the plurality of types comprising an object detection type of the image quality issue, a depth type of the image quality issue, and an image payload type of the image quality issue; and
generating image quality feedback associated with the plurality of images, the image quality feedback comprising the type of the image quality issue and the payload data associated with the plurality of images.

16. The one or more computer storage devices of claim 15, wherein the operations further comprise:
analyzing the object recognition results generated by the ML CV model;
identifying a set of images in the plurality of images having an absence of recognition of the object of interest within the plurality of images; and
generating the image quality feedback associated with the set of images, wherein the type of the image quality issue is the object detection type.

17. The one or more computer storage devices of claim 15, wherein the operations further comprise:
analyzing the object recognition results generated by the ML CV model;
identifying a set of images in the plurality of images having a number of instances of the object of interest within the plurality of images exceeding a threshold number of instances, the object of interest comprising an information tag associated with an item; and
generating the image quality feedback associated with the set of images, wherein the type of the image quality issue is the object detection type.

18. The one or more computer storage devices of claim 15, wherein the operations further comprise:
analyzing the depth information generated by a depth estimation model;
identifying a set of images in the plurality of images having a distance between the object of interest and the image capture device that exceeds a maximum threshold distance; and
generating the image quality feedback associated with the set of images, wherein the type of the image quality issue is the depth type.

19. The one or more computer storage devices of claim 15, wherein the operations further comprise:
analyzing the depth information generated by a depth estimation model;
identifying a set of images in the plurality of images having a distance between the object of interest and the image capture device that falls below a minimum threshold distance; and
generating the image quality feedback associated with the set of images, wherein the type of the image quality issue is the depth type.

20. The one or more computer storage devices of claim 15, wherein the operations further comprise:
analyzing the depth information generated by a depth estimation model;
identifying a set of images in the plurality of images having an inconsistent distance between the object of interest and the image capture device; and
generating the image quality feedback associated with the set of images, wherein the type of the image quality issue is the depth type.
